(19) United States
(12) Patent Application Publication
(10) Pub. No.: US 2010/0117831 A1
(43) Pub. Date: May 13, 2010

(54) COMMODITY SALES DATA PROCESSING APPARATUS AND CONTROL METHOD THEREFOR

(75) Inventor: Yasuhiro Katabira, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/614,932

(22) Filed: Nov. 9, 2009

(30) Foreign Application Priority Data
Nov. 11, 2008 (JP) 2008-289090

(51) Int. Cl. G08B 13/12; G08B 13/14

(52) U.S. Cl. 340/568.3

(57) ABSTRACT

A commodity sales data processing apparatus includes a power supply unit configured to switch a power supply source for a control circuit to an auxiliary power supply when power supply from the outside is stopped and a movement detecting unit configured to detect the movement of a main body of the commodity sales data processing apparatus. The commodity sales data processing apparatus causes an alarming unit to generate an alarm according to the switch of the power supply source for the control circuit to the auxiliary power supply by the power supply unit and the detection of the movement of the main body by the movement detecting unit.

### CROSS REFERENCE TO RELATED APPLICATION

This application is based upon and claims the benefit of priority from the prior Japanese Patent Application No. 2008-289090, filed Nov. 11, 2008, the entire contents of which are incorporated herein by reference.

### TECHNICAL FIELD

The present invention relates to a commodity sales data processing apparatus that performs checkout processing for transactions in a commodity sales store, a service providing store, and the like and a control method therefor.

### BACKGROUND

A commodity sales data processing apparatus such as a POS (Point Of Sales) terminal is used for checkout processing for transactions in a commodity sales store and a service providing store. The commodity sales data processing apparatus stores various kinds of important information in a memory installed in the inside thereof. For example, a commodity sales data processing apparatus that can perform settlement using a credit card and a debit card encrypts communication texts and transmits and receives the communication texts to and from a host computer of a financial institution designated by a card for settlement to improve security. Therefore, key data required for encryption and restoration of a cryptogram is recorded in advance in a memory incorporated in the commodity sales data processing apparatus. If the key data is used, since access to the host computer of the financial institution is possible without the intervention of a data processing apparatus, illegal acts can be easily committed. When a sales amount, a password for a store system, and the like are stored in the memory, it is likely that these kinds of information are also illegally acquired. Further, since a large amount of money may be stored in a drawer incorporated in or connected to the commodity sales data processing apparatus, thefts targeting the money could occur. When a person who attempts to illegally acquire various data or steal the money in this way carries away a main body of the commodity sales data processing apparatus together with the data or the money, there is probability that even a security system and the like of a POS terminal is known.

In view of such circumstances, various inventions for improving security of commodity sales data processing apparatuses are devised. For example, like a cash register described in JP-A-2004-145391, some commodity sales data processing apparatus includes a theft preventing device that sounds an alarm when a vibration sensor senses vibration.

However, the theft preventing device described in JP-A-2004-145391 detects vibration caused when a drawer is opened. An operation state and a stop state of the theft preventing device are switched according to whether power is supplied. Therefore, a cashier needs to switch the theft preventing device from the stop state to the operation state every time the cashier looks away from the commodity sales data processing apparatus. Further, when the cashier opens the drawer in a usual job, if the cashier fails to switch the theft preventing device to the stop state, the alarm is sounded.

### SUMMARY

The present invention has been devised in view of such circumstances and it is an object of the present invention to provide a commodity sales data processing apparatus including an alarming unit that does not operate when a usual job is only performed and operates when abnormality apparently occurs and a control method for the commodity sales data processing apparatus.

According to an aspect of the present invention, there is provided a commodity sales data processing apparatus including: a power supply unit configured to switch a power supply source for a control circuit to an auxiliary power supply when power supply from the outside is stopped; a movement detecting unit configured to detect the movement of a main body of the commodity sales data processing apparatus; and an alarming unit configured to emit an alarm according to the switch of the power supply source for the control circuit to the auxiliary power supply by the power supply unit and the detection of the movement of the main body by the movement detecting unit.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is an external perspective view of a commodity sales data processing apparatus according to an embodiment of the present invention;

FIG. 2 is a block diagram of a control circuit of the commodity sales data processing apparatus according to the embodiment;

FIG. 3 is a flowchart of an example of switch setting processing according to the embodiment; and

FIG. 4 is a flowchart of an example of processing performed by units of the control circuit according to the embodiment.

### DETAILED DESCRIPTION

An embodiment of the present invention is explained below with reference to the accompanying drawings.

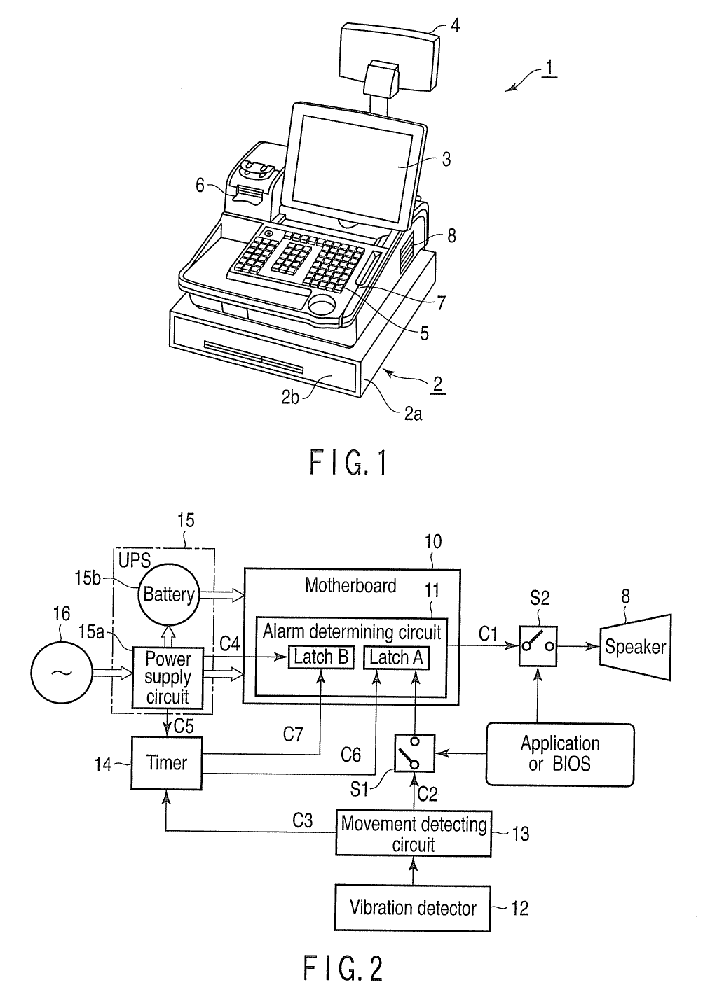

FIG. 1 is an external perspective view of a commodity sales data processing apparatus 1 according to this embodiment. The commodity sales data processing apparatus 1 includes a drawer 2 and a main body placed on the upper surface of the drawer 2. The main body of the commodity sales data processing apparatus 1 includes a cashier display 3, a customer display 4, a keyboard 5, a receipt printer 6, a card reader 7, and a speaker 8 as a sound output unit.

The cashier display 3 includes a touch panel that displays various kinds of information corresponding to commodity sales processing and the like and recognizes a touch operation position on a screen.

The customer display 4 displays a total amount of a transaction, a change amount, and the like.

The keyboard 5 includes a ten key, a PLU (Price

Look Up) key, a subtotal key, and a cash total key and the like. The ten key is an operation key used for inputting a numerical value. The PLU key is an operation key for declaring the start of registration processing for commodity information. The subtotal key is an operation key for declaring calculation of a total amount of a transaction. The cash total key is an operation key for calculating a change amount and completing the transaction.

The receipt printer 6 issues, according to the operation of the cash total key, a receipt on which details of the transaction are printed.

The card reader 7 reads information stored in a magnetic card such as a credit card slid in a reading groove provided in a housing. The commodity sales data processing apparatus 1 can perform card settlement in a well-known procedure on the basis of the information read by the card reader 7.

The speaker 8 emits operation sound of the keyboard 5 and alarm sound explained later.

The drawer 2 includes a case 2a and a money storing unit 2b housed in the case 2a. The money storing unit 2b stores change and the like therein and is urged in a direction of an opening surface of the case 2a by a not-shown spring. In a state in which the money storing unit 2b is completely housed in the case 2a, the money storing unit 2b is locked by a not-shown locking member. In this case, the state in which the money storing unit 2b is housed in the case 2a is maintained. The lock by the locking member is released according to the operation of a predetermined operation key such as the cash total key provided in the keyboard 5. When the lock by the locking member is released, the money storing unit 2b is opened in a sliding manner relatively to the case 2a. After the money storing unit 2b is once opened, the money storing unit 2b can be housed in the case 2a again by sliding the money storing unit 2b against the urging force of the spring.

The commodity sales data processing apparatus 1 includes a theft prevention mechanism for detecting the movement of the main body and the drawer 2 and emitting alarm sound. The theft prevention mechanism is explained below.

FIG. 2 is a block diagram of a section necessary for realizing the theft prevention mechanism in the control circuit of the commodity sales data processing apparatus 1. The control circuit includes a motherboard 10 including an alarm determining circuit 11 as an alarming unit, a vibration detector 12 as a vibration detecting unit, a movement detecting circuit 13 as a movement detecting unit, a timer 14 as a time measuring unit, a UPS (uninterrupted power supply circuit) 15, and switches S1 and S2.

The alarm determining circuit 11 outputs a control signal C1 when both latches A and B are set. The control signal C1 is transmitted to the speaker 8 when the switch S2 is set to ON. The speaker 8 sounds alarm sound according to the reception of the control signal C1. The latches A and B are holding circuits that maintain, if once set, a set state until the latches A and B are reset thereafter.

The vibration detector 12 outputs an electric signal to the movement detecting circuit 13 while the vibration detector 12 detects the vibration of the commodity sales data processing apparatus 1. The movement detecting circuit 13 specifies, on the basis of an electric signal input from the vibration detector 12, duration of the vibration or a period of the vibration and determines whether the vibration is abnormal vibration. The abnormal vibration is not vibration caused when the cashier only operates the keyboard 5 or opens and closes the drawer 2 in a usual job but is vibration caused when someone attempts to carry away or destroy the commodity sales data processing apparatus 1. Therefore, the duration of the vibration is not time of length in which the cashier or a customer only loses balance and touches the commodity sales data processing apparatus 1 but is time of, for example, about 10 seconds or longer. The period of the vibration is not a period of a high frequency or an extremely low frequency like the vibration of a waste heat fan caused when the commodity sales data processing apparatus 1 and peripheral electronic devices are operating but is a period of, for example, a human walk. When the movement detecting circuit 13 determines that the vibration is the abnormal vibration, the movement detecting circuit 13 outputs a control signal C2 to the alarm determining circuit 11 and outputs a control signal C3 to the timer 14 assuming that the movement of the commodity sales data processing apparatus 1 is detected. The control signal C2 is transmitted to the alarm determining circuit 11 when the switch S1 is set to ON. The alarm determining circuit 11 sets the latch A according to the reception of the control signal C2.

The UPS 15 includes a power supply circuit 15a as a power supply unit and a battery 15b as an auxiliary power supply. The power supply circuit 15a rectifies the AC voltage of a commercial AC power supply 16, charges the battery 15b with DC voltage after the rectification, and converts the DC voltage after the rectification into DC voltage at a predetermined level and supplies the DC voltage to the control circuit. The power supply circuit 15a monitors whether power is supplied from the commercial AC power supply 16. When the power supply from the commercial AC power supply 16 is stopped, for example, when a plug for connecting the commodity sales data processing apparatus 1 and the commercial AC power supply 16 comes off or service interruption occurs, the power supply circuit 15a switches the power supply source for the control circuit from the commercial AC power supply 16 to the battery 15b. Consequently, the control circuit can operate with power stored in the battery 15b even after the power supply from the commercial AC power supply 16 is stopped. Thereafter, when the plug is connected or the power supply is restored, the power supply circuit 15a detects resumption of the power supply from the commercial AC power supply 16 and switches the power supply source for the control circuit from the battery 15b to the commercial AC power supply 16. When the power supply circuit 15a switches the power supply source from the commercial AC power supply 16 to the battery 15b as explained above, the power supply circuit 15a outputs a control signal C4 to the alarm determining circuit 11 and outputs a control signal C5 to the timer 14. The alarm determining circuit 11 sets the latch B according to the output of the control signal C4.

The timer 14 starts measurement of a predetermined time according to the reception of the control signal C3 from the movement detecting circuit 13 or the reception of the control signal C5 from the power supply circuit 15a. When the measurement of the predetermined time is already started, the timer 14 continues the measurement even if the timer 14 thereafter receives the control signals C3 and C5. When the measurement of the predetermined time is completed, the timer 14 outputs control signals C6 and C7 to the alarm determining circuit 11 and stops the measurement. The alarm determining circuit 11 resets the latches A and B according to the reception of the control signals C6 and C7, respectively.

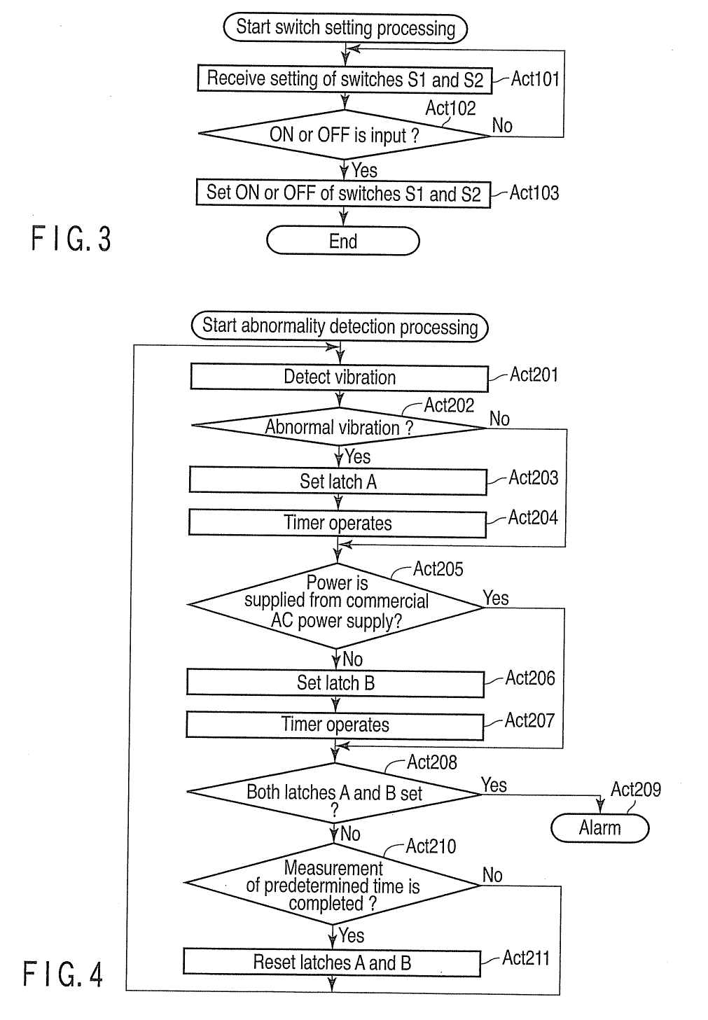

The switches S1 and S2 can be set to ON or OFF according to operation by a predetermined application executed in a state in which a system of the commodity sales data processing apparatus 1 is started or operation by a BIOS (Basic Input/Output System) during system startup (a setting unit). This switch setting processing is explained with reference to a flowchart of FIG. 3.

First, the application or the BIOS controls the cashier display 3 to display a setting screen for the switches S1 and S2 on the cashier display 3 and receives the input of ON or OFF of the switches S1 and S2 (Act 101). At this point, a user can input ON or OFF of the switches S1 and S2 with key operation of the keyboard 5 or touch operation of the cashier display 3. In a state in which the setting screen is displayed, a control unit such as a CPU (Central Processing Unit) determines presence or absence of the input of ON or OFF (Act 102). If ON or OFF of the switches S1 and S2 is input (Yes in Act 102), the control unit stores a type of ON or OFF of the switches S1 and S2 in a not-shown nonvolatile memory and ends the processing (Act 103). After the setting of the switches S1 and S2 are performed in this way, the switches S1 and S2 are switched according to the setting stored in the memory.

Processing by the control circuit is explained below.

Processing performed by the units of the control circuit is explained with reference to a flowchart of FIG. 4 on the assumption that a person attempting to steal the commodity sales data processing apparatus 1 attempts to carry away the main body and the drawer 2 from the store all together. In an example explained below, it is assumed that both the switches S1 and S2 are set to ON.

First, the vibration detector 12 detects vibration caused when the person attempting to steal the commodity sales data processing apparatus 1 attempts to lift the same (Act 201). The vibration detector 12 outputs an electric signal to the movement detecting circuit 13 while the vibration is detected. The movement detecting circuit 13 determines, on the basis of the input electric signal, whether this vibration is the abnormal vibration (Act 202). If the electric signal is output from the vibration detector 12 continuously for the predetermined time or more as explained above or when the electric signal is output at a predetermined period, the movement detecting circuit 13 determines that the vibration is the abnormal vibration (Yes in Act 202). The movement detecting circuit 13 outputs the control signal C2 to the alarm determining circuit 11 and outputs the control signal C3 to the timer 14 via the switch S2 assuming that the movement of the commodity sales data processing apparatus 1 is detected. The alarm determining circuit 11 sets the latch A according to the reception of the control signal C2 (Act 203). The timer 14 starts the measurement of the predetermined time according to the reception of the control signal C3 (Act 204). If the movement detecting circuit 13 determines that the vibration detected by the vibration detecting circuit 13 is not the abnormal vibration (No in Act 202), the control signals C2 and C3 are not output. Therefore, the latch A is not set and the timer 14 does not operate.

As explained above, the power supply circuit 15a monitors whether the power is supplied from the commercial AC power supply 16 (Act 205). For example, when the person attempting to steal the commodity sales data processing apparatus 1 starts to carry the same and pulls out the plug by force, since the power supply from the commercial AC power supply 16 stops, the power supply source is switched to the battery 15b. If the power supply source is switched to the battery 15b in this way (No in Act 205), the power supply circuit 15a outputs the control signal C4 to the alarm determining circuit 11 and outputs the control signal C5 to the timer 14. The alarm determining circuit 11 that receives the control signal C4 sets the latch B (Act 206). The timer 14 that receives the control signal C5 starts the measurement of the predetermined time (Act 207). When the timer 14 already operates according to the control signal C3 output from the movement detecting circuit 13, the timer 14 continues the measurement of the predetermined time. On the other hand, if the power supply source is not switched to the battery 15b (Yes in Act 205), the control signals C4 and C5 are not output. Therefore, the latch B is not set. Even when the timer 14 is not operating yet, the timer 14 does not operate.

While such processing is performed, the alarm determining circuit 11 monitors whether the latches A and B are set (Act 208). If both the latches A and B are set (Yes in Act 208), the alarm determining circuit 11 outputs the control signal C1 to the speaker 8 via the switch S2. The speaker 8 that receives the control signal C1 emits predetermined alarm sound (Act 209). The speaker 8 continues to emit the alarm sound until predetermined release processing is performed or the power stored in the battery 15b is exhausted. On the other hand, if at least one of the latches A and B is not set (No in Act 208), since the alarm determining circuit 11 does not output the control signal C1, the speaker 8 does not emit the alarm sound.

After operating according to the reception of the control signal C3 output from the movement detecting circuit 13 or the control signal C5 output from the power supply circuit 15a, if the measurement of the predetermined time is completed (Yes in Act 210), the timer 14 outputs control signals C6 to C7 to the alarm determining circuit 11. The alarm determining circuit 11 resets the latches A and B according to the reception of the control signals C6 and C7 (Act 211).

As explained above, the control circuit monitors presence or absence of the vibration of the commodity sales data processing apparatus 1 and the power supply from the commercial AC power supply 16. After one of the detection of the abnormal vibration and the stop of the power supply from the commercial AC power supply 16 is detected, the speaker 8 emits the alarm sound when the other is detected until the predetermined time is measured by the timer 14. Therefore, when a store clerk only moves a setting location of the commodity sales data processing apparatus 1 slightly in a usual job, even if vibration is detected, the alarm sound is not emitted unless the plug of the power supply is pulled out. For example, even when the plug of the power supply is pulled out or service interruption occurs, the alarm sound is not emitted unless vibration large enough for being determined as the abnormal vibration by the movement detecting circuit 13 is applied to the commodity sales data processing apparatus 1.

When the switch S1 is set to OFF, the control signal C2 output from the movement detecting circuit 13 is not transmitted to the alarm determining circuit 11. Therefore, the power supply from the commercial AC power supply 16 to the commodity sales data processing apparatus 1 stops. The speaker 8 does not emit the alarm sound even if vibration is applied to the commodity sales data processing apparatus 1.

When the switch S2 is set to OFF, the control signal C1 output from the alarm determining circuit 11 is not transmitted to the speaker 8. Therefore, the power supply from the commercial AC power supply 16 to the commodity sales data processing apparatus 1 stops. The speaker 8 does not emit the alarm sound even if vibration is applied to the commodity sales data processing apparatus 1. In such a case, even when the system of the commodity sales data processing apparatus 1 is shut down, the system may be automatically started to display a warning message on the cashier display 3.

By setting ON or OFF of the switches S1 and S2 as explained above, it is possible to change the determination concerning whether an alarm should be given and whether alarm sound should be emitted even when the alarm should be given. Therefore, for example, when the commodity sales data processing apparatus 1 is moved on account of a job, the switches S1 and S2 can be set such that the alarm is not given.

In the embodiment, the movement detecting circuit 13 detects the movement of the commodity sales data processing apparatus 1 on the basis of the electric signal output when the vibration detector 12 detects vibration. However, a method of detecting the movement of the commodity sales data processing apparatus 1 is not limited to this. For example, a tilt detector (a tilt detecting unit) that detects a tilt of the commodity sales data processing apparatus 1 is provided instead of the vibration detector 12. The tilt detector outputs an electric signal having different voltage according to, for example, a tilt from the horizontal direction of the commodity sales data processing apparatus 1. When the commodity sales data processing apparatus 1 tilts, the movement detecting circuit 13 specifies a tilt angle of the commodity sales data processing apparatus 1 on the basis of the voltage of the electric signal output from the tilt detector. When the tilt angle is equal to or larger than a predetermined angle, the movement detecting circuit 13 outputs the control signal C2 to the alarm determining circuit 11 and outputs the control signal C3 to the timer 14 assuming that the movement of the commodity sales data processing apparatus 1 is detected.

Alternatively, the vibration detector 12 and the tilt detector may be used together. In such a case, for example, when the electric signal is continuously output from the vibration detector 12 for the predetermined time or more or the electric signal is output at the predetermined period as explained above or when the tilt angle of the commodity sales data processing apparatus 1 specified on the basis of the electric signal output from the tilt detector is equal to or larger than the predetermined angle, the movement detecting circuit 13 outputs the control signal C2 to the alarm determining circuit 11 and outputs the control signal C3 to the timer 14.

Rather than setting the latch A according to the detection of the movement of the main body of the commodity sales data processing apparatus 1 by the movement detecting circuit 13, the latch A may be set according to the detection of vibration by the vibration detector 12. Even when the latch A is set in this way, as long as vibration is detected and the power supply source is not switched to the battery 15b, the alarm determining circuit 11 does not output the control signal C1. Therefore, an alarm is not emitted only by the opening of the drawer 2 or the contact of the store clerk.

In the embodiment, the switch setting processing is performed according to the operation from the application or the BIOS. However, other setting methods may be adopted for the switch setting processing. For example, a key switch operable by a predetermined key is provided in the main body of the commodity sales data processing apparatus 1. ON or OFF of the switches S1 and S2 may be set according to the operation of the key switch. When the user performs the switch setting processing using the application, the BIOS, or the key switch, the user is requested to input a password. The setting of the switches S1 and S2 may be received only when the input password coincides with a password set in advance.

In the embodiment, in the flowchart shown in FIG. 4, after the processing concerning movement detection (Act 201 to Act 204), the processing concerning power supply (Act 205 to Act 207) is performed. However, the processing concerning movement detection and the processing concerning power supply may be carried out in opposite order.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A commodity sales data processing apparatus comprising:
a power supply unit configured to switch a power supply source for a control circuit to an auxiliary power supply when power supply from an outside is stopped;
a movement detecting unit configured to detect movement of a main body of the commodity sales data processing apparatus; and
an alarming unit configured to emit an alarm according to the switch of the power supply source for the control circuit to the auxiliary power supply by the power supply unit and the detection of the movement of the main body by the movement detecting unit.

2. The apparatus according to claim 1, further comprising a sound output unit configured to output sound, wherein
the alarming unit causes the sound output unit to generate alarm sound according to the switch of the power supply source for the control circuit to the auxiliary power supply by the power supply unit and the detection of the movement of the main body by the movement detecting unit.

3. The apparatus according to claim 1, further comprising a time measuring unit configured to measure time, wherein
the alarming unit emits an alarm according to the switch of the power supply source for the control circuit to the auxiliary power supply by the power supply unit and the detection of the movement of the main body by the movement detecting unit while predetermined time is measured by the time measuring unit.

4. The apparatus according to claim 3, wherein the time measuring unit starts the measurement of the predetermined time when the power supply source for the control circuit is switched to the auxiliary power supply by the power supply unit or when the movement of the main body is detected by the movement detecting unit.

5. The apparatus according to claim 1, further comprising a vibration detecting unit configured to detect vibration of the main body, wherein
the movement detecting unit detects the movement of the main body on the basis of the vibration detected by the vibration detecting unit.

6. The apparatus according to claim 5, wherein the movement detecting unit detects the movement of the main body on the basis of duration of the vibration detected by the vibration detecting unit or a period of the vibration.

7. The apparatus according to claim 1, further comprising a tilt detecting unit configured to detect a tilt of the main body, wherein
the movement detecting unit detects the movement of the main body on the basis of the tilt detected by the tilt detecting unit.

8. The apparatus according to claim 1, further comprising a setting unit configured to set necessity or unnecessity of an alarm by the alarming unit, wherein
the alarming unit does not emit the alarm when the unnecessity of the alarm is set by the setting unit.

9. A commodity sales data processing apparatus comprising:
a power supply unit configured to switch a power supply source for a control circuit to an auxiliary power supply when power supply from an outside is stopped;
a vibration detecting unit configured to detect vibration of a main body of the commodity sales data processing apparatus; and
an alarming unit configured to emit an alarm according to the switch of the power supply source for the control circuit to the auxiliary power supply by the power supply unit and the detection of the vibration of the main body by the vibration detecting unit.

10. The apparatus according to claim 9, further comprising a sound output unit configured to output sound, wherein
the alarming unit causes the sound output unit to generate alarm sound according to the switch of the power supply source for the control circuit to the auxiliary power supply by the power supply unit and the detection of the vibration of the main body by the vibration detecting unit.

11. The apparatus according to claim 9, further comprising a time measuring unit configured to measure time, wherein
the alarming unit emits an alarm according to the switch of the power supply source for the control circuit to the auxiliary power supply by the power supply unit and the detection of the vibration of the main body by the vibration detecting unit while predetermined time is measured by the time measuring unit.

12. The apparatus according to claim 11, wherein the time measuring unit starts the measurement of the predetermined time when the power supply source for the control circuit is switched to the auxiliary power supply by the power supply unit or when the vibration of the main body is detected by the vibration detecting unit.

13. The apparatus according to claim 9, further comprising a setting unit configured to set necessity or unnecessity of an alarm by the alarming unit, wherein
the alarming unit does not emit the alarm when the unnecessity of the alarm is set by the setting unit.

14. A control method for a commodity sales data processing apparatus including a control circuit that operates according to reception of power supply from an external power supply or an auxiliary power supply, the control method comprising:
switching a power supply source for the control circuit to the auxiliary power supply when the power supply from the external power supply is stopped;
detecting movement of a main body of the commodity sales data processing apparatus; and
emitting an alarm according to the switch of the power supply source for the control circuit to the auxiliary power supply and the detection of the movement of the main body.
